(19) United States
(12) Patent Application Publication
(10) Pub. No.: US 2003/0183617 A1
(43) Pub. Date: Oct. 2, 2003

(54) Cooktop display insert

(75) Inventor: Nils Platt, New Bern, NC (US)

Correspondence Address: BROOKS & KUSHMAN, 1000 TOWN CENTER 22ND FL, SOUTHFIELD, MI, 48075

(73) Assignee: BSH Home Appliances Corporation, Huntington Beach, CA

(21) Appl. No.: 10/109,248

(22) Filed: Mar. 28, 2002

(51) Int. Cl. H05B 3/68

(52) U.S. Cl. 219/452.11; 219/460.1

(57) ABSTRACT

A dark transmissive ceramic glass cooktop panel insert is retained in an opening in a colored cooktop glass ceramic panel to provide a visible area for illumination elements representative of controls for or displays of the cooktop operation. Illumination elements are supported at a position adjacent to the ceramic glass surface insert panel in the cooktop panel opening. A control activates the illumination elements at least in response to burner operations. A method for forming a cooktop surface over burners includes defining an opening in a colored glass ceramic cooktop panel at an area adjacent illumination elements, dimensioning of a glass ceramic insert panel to fit at least a portion of the opening, and supporting the insert panel at the periphery of the opening in the cooktop panel. Preferably, the insert panel supports a frame to provide one-piece removal or installation of the insert and the control.

### BACKGROUND OF THE INVENTION

1. Field of the Present Invention

The present invention is a method and an apparatus for a cooktop panel control insert made of transmissive ceramic glass to be received in a ceramic glass panel cooktop, and supported in an opening in the cooktop panel.

2. Background Art

Cooktops that includes burners for cooking have often included burner elements and electronic controls for the burners that are exposed at the top of the appliance and subject to spillage from pots or cooking utensils used on the cooktop surface. Although the controls and the burners have been redesigned in numerous fashions, such improvements may actually increase the difficulty of cleaning and maintaining the proper operation of the cooktop. Accordingly, some cooktops have been developed to include an upper panel that covers the heating elements for aesthetic purposes as well as ease of cleaning the upper panel surface in the burner areas of the cooktop.

Another development in cooktops has been controls that are also exposed to view through the top surface of the cooktop panel so as to be readily visible to and manipulated by a user of the cooking appliance. Nevertheless, the ceramic glass panels are often dark colored panels so that the burner features and control features mounted beneath the cooktop panel are not readily visible to the user except as they are illuminated during operation of the cooktop. However, such cooktop panels are difficult to coat or otherwise colored to match other appliances or decor. In particular, lighter colors for aesthetic purposes obscure the visibility of illuminated controls and interfere with transmission of the illumination through the panel and obscure detection by the user. For example, while a white ceramic glass panel surface may be popular for aesthetic reasons, but glowing burner elements, or light displays representative of burner operation, may not be readily visible through the top surface of the panel.

### SUMMARY OF THE INVENTION

The present invention overcomes the mentioned disadvantages by providing a method and apparatus for supporting a transmissive surface control panel insert in a ceramic glass cooktop panel. The insert panel is sized to fit within the opening and is carried by a frame. Preferably, the frame carries illumination elements at a position supported adjacent to the ceramic glass surface of the insert panel. The surrounding ceramic glass surface of the cooktop supports the insert at the periphery of the opening, preferably by a decorator frame peripherally coupled to the insert panel. An illumination control activates the illumination elements in response to burner operating conditions.

In the preferred embodiment, a cooktop panel covers the burners of a cooktop, and the panel defines an opening in a colored glass ceramic panel. By dimensioning a glass ceramic insert panel to fit at least a portion of said opening, and providing support for the insert panel in the opening, preferably at the level of the cooktop surface level, the illumination elements, such as burner elements, control displays and the like, carried below the insert panel may be visible through the insert panel at the surface of the cooktop panel regardless of the color or transmissivity of the cooktop panel.

In the preferred embodiment, an edge of the insert panel is received in a channel and retained by a resilient flange of a decorator frame carried by the insert panel. In addition, the decorator frame snap-in fits into the opening in the cooktop ceramic glass panel using a similar channel and retaining flange structure. The illuminating members visible through the insert panel surface are preferably aligned with control indicia, also visible on the cooktop surface, so as to provide correlated information to the user regarding the burner elements and other controls operable from the insert by the user.

### BRIEF DESCRIPTION OF THE DRAWINGS

The present invention will be more clearly understood by reference to the following detailed description of a preferred embodiment when read in conjunction with the accompanying drawing, in which like reference characters refer to like parts throughout the views, and in which

FIG. 1 is a perspective view of a cooking appliance employing a cooktop constructed in accordance with the present invention;

FIG. 2 is an enlarged sectional view taken substantially along the line 2-2 in FIG. 1;

FIG. 3 is an enlarged sectional view similar to FIG. 2 but showing a modified structure for supporting the cooktop insert according to the present invention;

FIG. 4 is an enlarged plan view of the cooktop insert shown in FIGS. 1 & 2;

FIG. 5 is an enlarged sectional view similar to FIGS. 2 & 3 but showing further modification for supporting the cooktop insert in the cooktop panel according to the present invention; and

FIG. 6 is an exploded perspective view of the cooktop insert support shown in FIG. 5.

### DETAILED DESCRIPTION OF THE PREFERRED EMBODIMENT

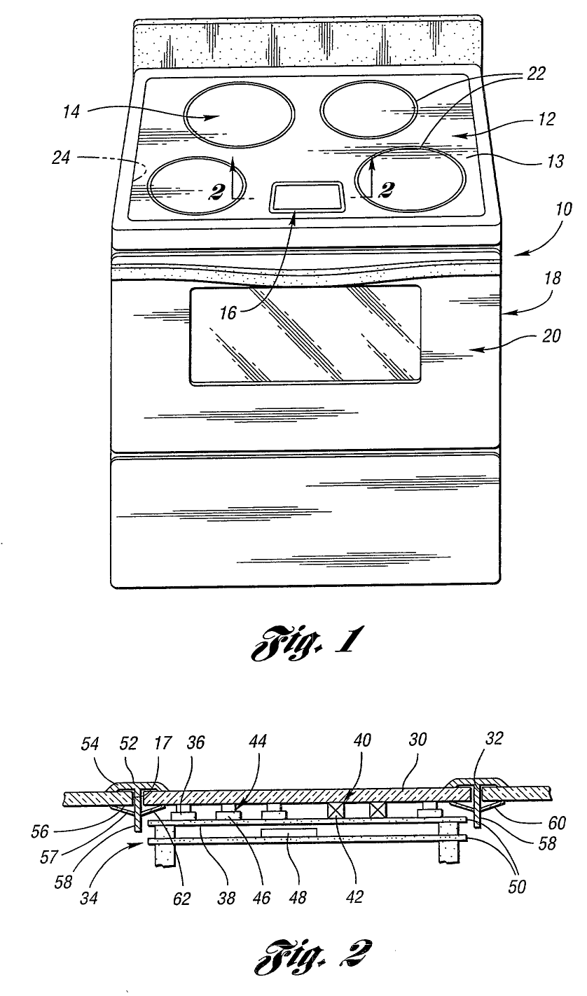

Referring first to FIG. 1, a cooking appliance 10 is shown including a cooktop 12 covering a plurality of burners. Multiple burner areas 14 are positioned around a cooktop control insert 16 according to the present invention. While the cooking appliance 10 of FIG. 1 includes a dedicated housing 18 arranged to support the cooktop 12 above an oven 20, other structures may be used to construct an appliance 10 in accordance with the present invention. For example, a cooktop 12 adapted to fit within an opening in a kitchen counter top, regardless of the function of the cabinetry below the cooktop, also remains part of the method and apparatus of the present invention.

In the preferred embodiment, the burner areas 14 are designated by indicia 22 visible from the top surface of the cooktop panel 13. Such indicia may be imprinted upon the panel or otherwise supported below the panel to be visible from a position above the panel. The cooktop 12 also includes burners and preferably, the means for supporting the burners below the surface of the cooktop panel 13, although the appliance housing 18 may also include supports for the components apart from the panel 13. In any event, the burners areas 14 are preferably at locations in the panel 13 separate from the control insert 16, and the insert 16 is conveniently located for access by a user standing in front of the appliance 10. Such convenience may be provided, for example, as shown in FIG. 1 at a central location between the burners toward the front of the appliance 10, although other locations for the insert 16 and the opening 17 in which it is received may be used as designated in phantom line at 24 in FIG. 1. For example, portions of the burner element may be adjacent the opening so that a glowing element forms an illumination element visible through the insert panel.

Referring now to FIG. 2, the cooktop 12 includes an insert panel 30, which is preferably of the same material used to form the cooktop panel 13, but without coloring agents, layers, pigments or coating applied to the panel 13 for decorating or color matching. Preferably, a glass ceramic panel is used to provide an easily cleaned, smooth surface. The panel 30 transmits sufficient light from indicia, display elements such as lights or illumination panels, or the burners themselves to illuminate hot areas, representations of hot areas and/or control indicia through the top surface of the cooktop 12. The opening 32 receives the insert panel 30, as well as a frame 34 in the preferred embodiment, adjacent to illumination elements maintained below the panel 30. The frame 34 may be supported and carried by the panel 30, for example, by use of appropriate adhesives, or by mounting particular elements 36 on a circuit board 38, carried by the panel, or may be otherwise supported beneath the panel 30 so as to maintain a fixed position with respect to the opening 32.

The frame 34 carries illumination elements, for example, an LED or other known computer display components, at a position adjacent to the ceramic glass panel 30 of insert 16 in the opening 32. The display components on the frame 34 are preferably parts of an illumination control 44, for example, a lighting circuit including a touch sensitive switch 46, that is responsive to manipulation of controls performed on the surface of the control panel for controlling operation of the appliance. For example, the panel 30 may include physical or selectively visible indicia for selection of burners and their operation as is defined in copending application Ser. No. 09/884,370, entitled “Cooktop Control” and filed Jun. 19, 2001, incorporated herein by reference.

The frame 34 may be made in any convenient manner, for example, a stacked arrangement of circuit boards 50 that include illumination components 40 as well as other elements such as the touch-sensitive switches 46 and other control circuit components for controlling the heater elements, sensors associated with temperature or with pot placement, displays and other components used to control the cooktop, or to control the cooktop as well as any other heating sources such as ovens included in the appliance 10. Nevertheless, while the frame 34 may be supported by the structure of elements of the housing 18, in the preferred embodiment of the insert 16, the frame 34 is secured for removal with the glass ceramic insert panel 30 for installation and removal in one piece therewith.

Referring again to FIG. 2, the insert 16 is supported in the panel 13 by a snap-in mounting formed by at least one channel in a framing member that peripherally supports the insert panel 30 by the periphery of the cooktop panel 13 about the opening 32. Preferably, the snap-in mounting includes a decorator frame 52 made of one or more pieces that surround the panel 30 along each edge of the panel 30. In the preferred embodiment, the decorator frame 52 includes a top flange 54 that ornamentally covers the opening extending between the panel 30 and the main cooktop panel 13. An outer channel 56 is formed with the flange 54 by a spring biased flange 57 extending from a leg 58 that depends from the flange 54. Similarly, an interior retention channel 60 is formed by a flange 62 that is resiliently urged toward the flange 54 to engage the edge of a panel 30 in the cavity 60.

Referring now to FIG. 3, a snap-in mounting may also be provided by an appliance housing having support walls for supporting the insert panel 30. In the preferred embodiment shown in FIG. 3, a support wall 64 of the appliance housing 18 carries a resilient flange 66. The flange 66 includes a slot, formed by legs 68 and 70, that receive the edge of the panel 30. As shown in the drawing, a return bent lip 69 from leg 68 engages the top surface of the insert panel 30 while the resiliently protruding leg flange 70 engages the bottom surface of the insert panel 30. In such an embodiment, resilient retainer flange 66 forms a panel receiving channel formed by the legs 68 and 70 as well as a retainer channel 72 that receives the leg 58 of a trim flange 72.

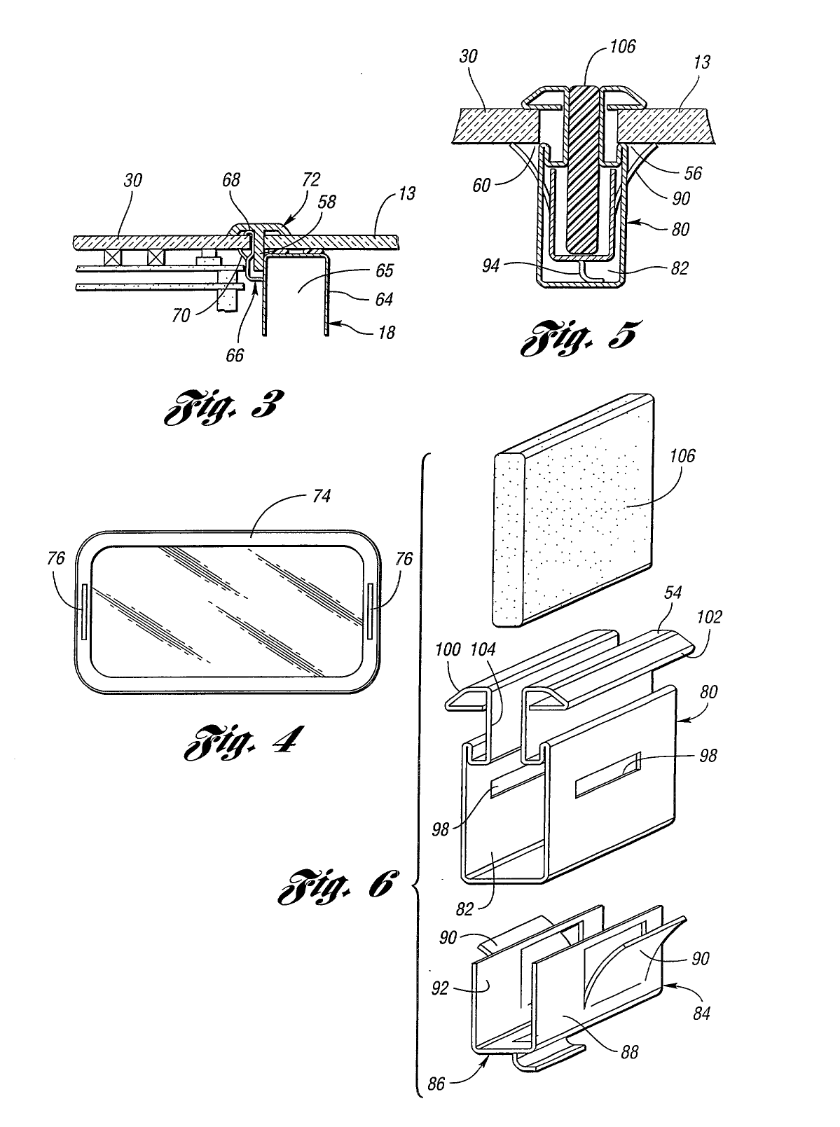

In the preferred embodiment shown in FIG. 1, the snap-in mounting is a one-piece peripheral framing member 74 (FIG. 4). One or more slots 76 formed in a leg of the frame 74, or in each of a plurality of separate frame members, receive a blade or other tool to aid in removal of the insert from the opening 17. As shown in FIG. 3, the wall 64 is made of spaced wall segments to provide an insulating chamber or layer 65 between the controls carried by the insert 16 and the heater elements carried under other portions of the cooktop panel 13.

Referring now to FIG. 5, a preferred snap-in mounting structure is shown comprising a channel member 80 dimensioned to be received intermediate the insert panel 30 and the cooktop panel 13. A channel 82 within the channel member 80 receives an expandable retainer 84 that may expand at least in part beyond the sides of the channel member 80 to extend beneath and engage the lower surface of the insert panel 30 and the cooktop panel 13. In the preferred embodiment, the expandable retainer 84 is formed from a channel member 86 whose side walls 88 include punch outs that are resiliently biased outwardly from the center channel 92. Similarly, a punch out 94 in the bottom wall of a stamped sheet metal channel member 84 resiliently urges the expandable retainer 84 upwardly within the channel 82, thereby forcing the punch outs 90 in the side walls of the member 86 outwardly through the openings 98 in the side walls of the channel member 80. Thus, the expandable member 84 cooperates with the double wall flange 54 at the top of the channel member 80 to form the cavities 60 and 56 that retain an insert panel 30 at the height of the cooktop panel 13 in a fixed position. Double-walled rails 100 and 102 that form the upper flange 54 are separated by a channel 104 in communication with the lower channel 82. The upper channel 104 receives a resilient trim pad 106, for example, a silicone rubber strand, that resiliently extends the double wall flanges 100 and 102 over the upper surface of the insert panel 30 and cooktop panel 13. In addition, the pad 106 finishes the appearance of the upper flange 54 by covering the spacing of channel 104 between the insert panel 30 and the cooktop panel 13.

Having thus described the present invention, many modifications thereto will become apparent to those skilled in the art to which it pertains without departing from the scope and spirit of the present invention as defined in the appended claims.

What is claimed is:

1. A cooktop panel comprising a colored glass ceramic panel having an opening;
a transmissive ceramic glass surface insert panel sized to fit within said opening;
a frame carrying said insert panel in said opening at a position supported adjacent to illumination elements carried below said ceramic glass surface; and
a control carried below said cooktop panel for activating said illumination elements responsive to burner operations.

2. The invention as described in claim 1 wherein said opening is a peripheral notch.

3. The invention as described in claim 1 and further comprising a snap-in mounting that peripherally supports said insert panel by the periphery of said colored panel about said opening.

4. The invention as described in claim 1 wherein a decorator frame spans adjacent edges of said colored panel and said insert panel.

5. The invention as described in claim 1 and comprising an appliance housing having support walls supporting said colored panel.

6. The invention as described in claim 5 wherein said support wall includes a resilient flange receiving an edge of said insert panel at the level of said colored panel.

7. The invention as described in claim 3 wherein said snap-in mounting comprises a channel member dimensioned to be received intermediate said insert panel and said colored panel, and an expandable retainer insertable into said channel member, and openings in said channel member permitting release of an expandable portion of said retainer.

8. The invention as described in claim 7 wherein said expandable retainer is a channel member.

9. The invention as described in claim 8 wherein said retainer channel member receives a trim.

10. The method for forming a cooktop surface over burners on a cooking appliance with a colored ceramic glass panel,
defining an opening in said colored glass ceramic panel adjacent to illumination elements carried below said cooktop surface;
dimensioning a glass ceramic insert panel to fit at least a portion of said opening;
supporting said insert panel at the cooktop panel; and
supporting a frame beneath said insert panel to expose illumination elements through said insert panel.

11. The invention as described in claim 10 and comprising controlling activation of at least a portion of said illumination elements in response to operation of said burners.

12. The invention as described in claim 10 wherein said supporting said insert panel comprises retaining an edge of said insert panel in a frame chamber by a resilient flange.

13. The invention as described in claim 11 wherein said retaining comprises expanding a resilient member below said insert panel.

14. The invention as described in claim 10 and comprising applying control indicia to a surface of said insert panel.
